(19) United States
(12) Patent Application Publication
(10) Pub. No.: US 2012/0253821 A1
(43) Pub. Date: Oct. 4, 2012

(54) VEHICULAR DEVICE AND METHOD FOR COMMUNICATING THE SAME WITH INFORMATION CENTER

(75) Inventor: Shinji Kamiya, Novi, MI (US)

(73) Assignee: DENSO CORPORATION, Kariya-city (JP)

(21) Appl. No.: 13/363,599

(22) Filed: Feb. 1, 2012

(30) Foreign Application Priority Data
Mar. 28, 2011 (JP) 2011-69888

(51) Int. Cl. G10L 11/00

(52) U.S. Cl. 704/270.1; 704/E11.001

(57) ABSTRACT

A communication unit is connected with an information center, which is receivable analog data, through an external network. A transmission unit transmits predetermined vehicle information in a form of a voice prompt of analog data when the communication unit is in connection with the information center.

### CROSS REFERENCE TO RELATED APPLICATIONS

This application is based on Japanese Patent Application No. 2011-69888 filed on Mar. 28, 2011, the contents of which are incorporated in their entirely herein by reference.

### TECHNICAL FIELD

The present invention relates to a vehicular device configured to transmit vehicle information to an information center. The present invention further relates to a method for communicating the vehicular device with information center.

### BACKGROUND

For example, JP-A-2002-127858 discloses a vehicular device affixed to a vehicle or being portable and configured, to notify an emergency information center of vehicle information, such as the type, the color, the number of the vehicle, automatically via a cell-phone network in a state of emergency, such as a traffic accident, caused when the vehicle travels. The emergency information center transmits the position from which the notification is sent and information required for a rescue activity, such as the vehicle information, to a nearby entity such as a police headquarter and/or a fire fighting headquarter, when receiving the vehicle information. In addition, an operator of the emergency information center talks with an occupant of the vehicle via a cell-phone network. In this way, the emergency information center confirms the condition of the vehicle.

It is conceivable that the vehicular device may become incommunicable with the emergency information center due to an unusual reason, such as a failure in the cell-phone network, a power failure, and/or the like. In this case, connection may be made with a nearby entity, such as a police headquarter, a fire fighting headquarter, and/or the like. With the present configuration, rescue (relief) is enabled in such a state of emergency. In addition, it is necessary to subscribe a paid emergency report system to connect with the emergency information center. In consideration of this, connection may be made with a specific telephone (cellular phone device) of a registered person such as a family member and/or an acquaintance, instead of the emergency information center. Thereby, the number of the connectable objects with the vehicular device can be increased, and thereby, flexibility of the vehicular device can be enhanced. Thus, rescue can be further facilitated in a state of emergency.

It is noted that, when the vehicular device is connected with a nearby entity such as a police headquarter, a fire fighting headquarter, or a specific telephone (cellular phone device), the connected nearby entity may be in a communication environment receivable only analog data. In such a case, the connected nearby entity may be unable to receive vehicle information including digital data transmitted from the vehicular device. Consequently, the connected nearby entity cannot implement a countermeasure to the state of emergency.

### SUMMARY

The present invention addresses the above disadvantage.

According to an aspect of the present invention, a vehicular device comprises a communication unit configured to connect with an information center, which is configured to receive analog data, through an external network. The vehicular device comprises a transmission unit configured to transmit predetermined vehicle information in a form of a voice prompt of analog data when the communication unit is in connection with the information center.

According to another aspect of the present invention, a method for communicating a vehicular device with an information center, which is configured to receive analog data and incapable of receiving digital data, the method comprises causing a communication unit of the vehicular device with the information center through an external network. The method further comprises causing a transmission unit of the vehicular device to transmit predetermined vehicle information in a form of a voice prompt of analog data correspondingly to the information center, when the communication unit is in connection with the information center.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an electrical configuration of a vehicular emergency report system according to one embodiment; and

FIG. 2 is a flow chart showing an operation of a vehicular device of the vehicular emergency report system.

### DETAILED DESCRIPTION

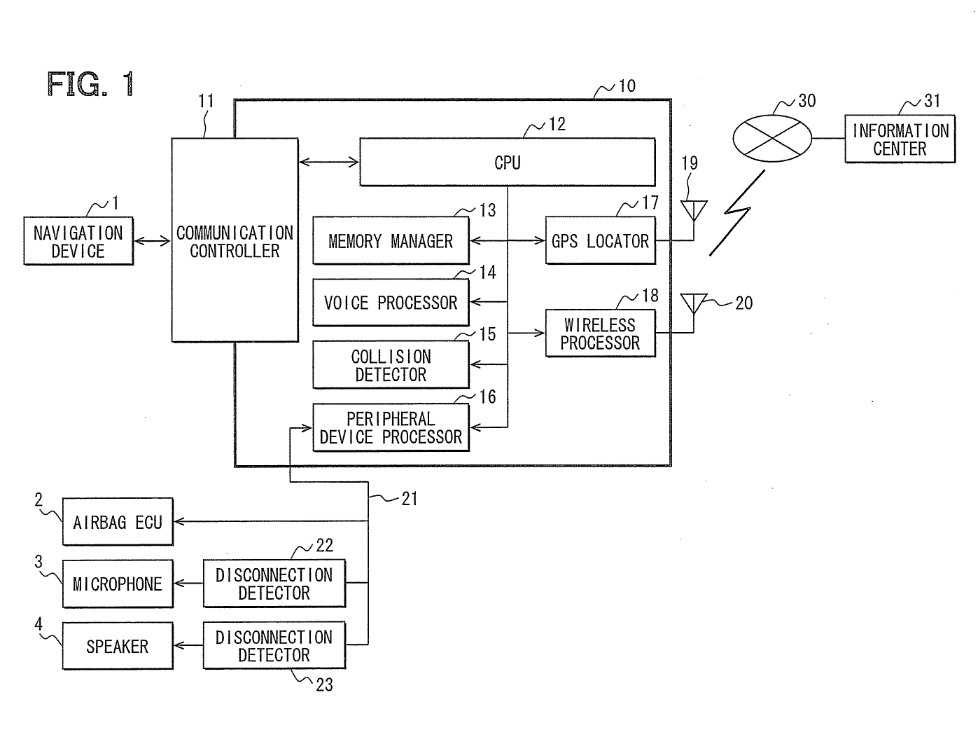

As follows, an embodiment of a vehicular emergency report system equipped in a vehicle will be described with reference to drawings. FIG. 1 is a block diagram showing an electric configuration of the vehicular emergency report system according to the embodiment. The vehicular emergency report system includes a vehicular navigation device 1 (operation unit, indication unit), an airbag ECU 2, a microphone 3, a speaker 4, a vehicular device 10, and the like.

The navigation device 1 may have a generally known configuration equipped with a touch-sensitive display device. The navigation device 1 indicates the present position of the vehicle on a map and searches a course to a destination thereby to indicate the searched course on the map.

The airbag ECU 2 has a control function to detect collision of the vehicle and to cause inflation of an airbag in response to detection of collision. The microphone 3 is located, for example, at a position, such as a steering wheel, close to a driver's seat and configured to convert a voice of an occupant into an audio signal. The speaker 4 also functions as a navigation speaker.

The vehicular device 10 includes a communication control unit 11, a CPU 12, a memory management unit 13, a voice processing unit 14, a collision detection unit 15, a peripheral device processing unit 16, a GPS locating unit 17, a wireless processing unit 18, and the like. The CPU 12 may function as a communication unit, a transmission unit, an emergency state detection unit, a receiver unit, a malfunction detection unit, and/or a storage unit.

The communication control unit 11 has a function to exchange data (signal) with the navigation device 1. The CPU 12 has a function to control entire vehicular devices. Specifically, the CPU 12 is configured to detect an operation to a button of the navigation device 1 (described later) and indicate an image on a display device of the navigation device 1. The CPU 12 is further configured to decode a duel tone multi-frequency signal (DTMF signal) received from an information center 31 and to determine an operated button based on the received signal. The memory management unit 13 has a function to store data temporarily. The voice processing unit 14 has a voice prompt function to synthesize a voice from voice data and a function to implement a digital processing on received voice data to enable recognition of the received voice data. The collision detection unit 15 has a function to detect operation of the airbag in response to a signal received from the airbag ECU 2. The peripheral device processing unit 16 has a function to exchange data (signal) with various vehicular devices, such as the airbag ECU 2, the microphone 3, and the speaker 4, through a wire harness 21. In the present example, the peripheral device processing unit 16 is connected with the microphone 3 through a disconnection detection unit 22 and is connected with the speaker 4 through a disconnection detection unit 23.

The GPS locating unit 17 has a function to receive a GPS signal through an antenna 19 to detect the present position. The wireless processing unit 18 has a function to implement wireless communications with the information center 31 through an antenna 20 and an external network 30. The external network 30 is configured with, for example, a cell-phone network or the like and configured to connect with the information center 31 in response to a call request.

The information center 31 is assigned as an emergency information center. It is noted that, when the emergency information center is incommunicable due to an unusual reason, such as a failure in a cell-phone network, a power failure, and/or the like, the information center 31 is configured to connect with a nearby entity, such as a police headquarter, a fire fighting headquarter, and/or the like. With the present configuration, rescue (relief) is enabled in a state of emergency. Alternatively, when a user does not subscribe an emergency report system, the information center 31 is configured to connect with a predetermined telephone device or a cellular phone device of a person such as a family member, an acquaintance, and/or the like. In this way, the vehicular device 10 is configured to have various kinds of connective objects thereby to have an enhanced flexibility. Thus, rescue is further facilitated in a state of emergency. Further, an operator (connection partner) of the information center 31 being connected and in communication implements voice communications with an occupant of the vehicle thereby to enable confirmation of occupant's safety and/or the condition of the vehicle.

It is noted that, when a telephone is communicated with the information center 31 as a nearby entity, such as a police headquarter, a fire fighting headquarter, or a person, instead of the emergency information center, the nearby entity may be capable of receiving only analog data due to its communication environment. In such a case, the nearby entity may not be capable of receiving digital data representing vehicle information. Consequently, the nearby entity cannot cope with the emergency.

In consideration of this, when transmitting the vehicle information to the information center 31 other than the emergency information center, the vehicular device 10 of the present embodiment is configured to transmit the vehicle information with a voice prompt including analog data. The voice prompt is implemented by using a voice codec function. For example, the voice prompt transmits a voice by decoding encoded data of a voice, which is beforehand encoded at an encoding speed below 16 kbps, by using the code excited linear prediction (CELP) algorithm. With the present configuration, even when the vehicular device 10 is connected with a telephone of a nearby entity, such as a police headquarter, a fire fighting headquarter, or a person, in a communication environment where only analog data are receivable, the vehicle information transmitted from the vehicular device 10 can be receivable as analog data to be read out with a voice.

It is noted that the microphone 3 and the speaker 4 are located outside the vehicular device 10 and are connected thereamong via the wire harness 21. Accordingly, the wire harness 21 may be disconnected due to an impact caused by collision. When the wire harness 21 is disconnected due to, for example, collision, it is conceivable to cause the vehicular device 10 to detect disconnection of the microphone 3 and/or the speaker 4 and to notify the information center 31 of the malfunction caused by the disconnection. In this way, communications, i.e., notification of the trouble, can be implemented between the vehicular device 10 and an operator of the information center 31.

It is noted that, when the vehicular device 10 is connected with the information center 31 being capable of receiving only analog data, as described above, the vehicular device 10 needs to transmit the vehicle information in the form of analog data. In consideration of this, the vehicular device 10 is further configured to transmit malfunction information of the microphone 3 and/or the speaker 4 in the form of the voice prompt.

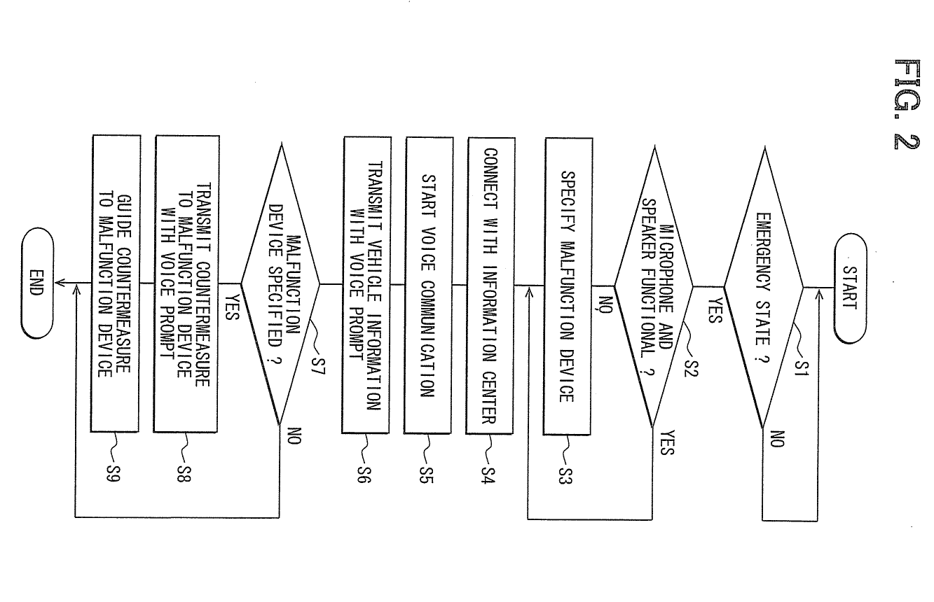

FIG. 2 is a flow chart showing a specific control processing of the vehicular device 10 according to the present embodiment. More specifically, FIG. 2 shows a processing to connect with the information center 31 other than an emergency information center. When collision or the like occurs to inflate the airbag in a state of emergency (S1: YES), the vehicular device 10 determines whether the microphone 3 and the speaker 4 are normally functional (S2). When the microphone 3 and the speaker 4 are normally functional (S2: YES), the vehicular device 10 calls the information center 31 and is connected with the information center 31 (S4). Thus, the vehicular device 10 starts voice communications (S5) with the information center 31 and transmits the vehicle information to the information center 31 in the form of the voice prompt (S6). The vehicle information includes, for example, the registration information on the vehicle, the position information, the owner information, the number of occupants, the ID information of the vehicular device, and/or the like. The vehicle information further includes, for example, information representing the occurrence time of the accident, the vehicle speed for determining whether the vehicle stops steadily, the battery voltage representing the remaining battery capacity, the ambient temperature, and/or the like. Subsequently, it is determined whether a malfunction device is specified (S6). In this case, a malfunction device is not specified (S6: NO), and therefore, the vehicular device 10 continues the voice communications.

Alternatively, when one or both the microphone 3 and the speaker 4 malfunctions (S2: NO), the vehicular device 10 specifies the malfunction device (S3). Subsequently, the vehicular device 10 transmits the vehicle information including the specified malfunction device (S6). Thereafter, the vehicular device 10 transmits a countermeasure corresponding to the malfunction device to the operator of the information center 31 in the form of the voice prompt (S7). Subsequently, the operator of the information center 31 guides a countermeasure corresponding to the malfunction device transmitted in the form of the voice prompt from the vehicular device 10. In response to the guidance from the information center 31, the vehicular device 10 guides an occupant the countermeasure corresponding to the malfunction device (S9).

In the above-described way, the vehicular device 10 notifies the malfunction device to the information center 31 thereby to enable the operator of the information center 31 to implement a suitable countermeasure corresponding to the malfunction device. The order of the processings is not limited to the order shown in the flow chart.

Subsequently, a detailed countermeasure corresponding to the malfunction device transmitted from the vehicular device 10 to the information center 31 will be described.

(When Microphone 3 Malfunctions)

When the microphone 3 malfunctions, an occupant can hear a voice of the operator of the information center 31 through the speaker 4, nevertheless, the operator cannot hear a voice of the occupant. Accordingly, the operator cannot figure out the state of an occupant of the vehicle, such as whether an occupant is alive or dead, existence of an injured person, and the number of occupants. Accordingly, even though an occupant may be safe in such a case, the operator has to dispatch an ambulance. In such a case, it is effective to notify the information center 31 of malfunction of the microphone 3. In consideration of this, the vehicular device 10 synthesizes a voice of “The microphone malfunctions and your voice may not be transferred.” and transmits the synthesized vice to the information center 31 in the form of the voice prompt.

When the operator of the information center 31 recognizes that the microphone 3 malfunctions according to the voice prompt transferred from the vehicular device 10, the operator determines whether the microphone 3 merely malfunctions, an occupant is losing consciousness, or the like. For example, the speaker 4 may be still functional normally in such a case. Therefore, even though the operator of the information center 31 cannot receive any audible response from the occupant, the operator may continue talking to the occupant in order to encourage the occupant. Specifically, the operator may talk “An ambulance will arrive in 5 minutes,” and/or “Although I cannot hear your voice due to malfunction of the microphone, I have requested a firefighting station to dispatch a fire track.” In addition, even if the microphone 3 malfunctions, the operator of the information center 31 may tell, for example, “Please press ◯◯ button” (◯◯ is optional), to try to receive a response from the occupant thereby to somehow make communications with each other. More specifically, in such a case, the operator may tell, for example, “When you are injured, please press the ◯◯ button once, or when you are fine, please press the ◯◯ button for 3 times.” In this way, the operator may give further questions according to occupant's response, thereby to figure out the present condition of the occupant and/or the present condition of the vehicle.

When the occupant is notified of malfunction of the microphone 3 from the information center 31, the occupant transmits information in the form of the voice prompt by operating the button of the navigation device 1, since the occupant cannot use the microphone 3.

Specifically, when an accident occurs, the vehicular device 10 calls the information center 31 and is connected with the information center 31. Further, the vehicular device 10 synthesizes a voice in the form of the voice prompt and transmits the synthesized voice representing the following contents to both the information center 31 and the occupant thereby to determine whether communications by the button operation is possible. Specifically, the audio guidance is made in the form of the voice prompt to include the contents of, “This is a report of detection of collision inflating an airbag. The vehicle ID is Mikawa, ◯◯◯, Δ-XX-YY. The registered owner is Mr. ΔΔ. The vehicle position is at the longitude xx east and at the latitude yy north. The number of occupants may be zz. Please talk from the center side to the occupant. The microphone of the vehicle may malfunction according to the self-diagnostic result. Therefore, the communications may be one-way” (◯◯◯, Δ, XX, YY, ΔΔ, xx, yy, zz are optional). When, for example, 30 seconds elapse, further voice guidance is implemented to tell, “Guidance will follow to request operation for figuring out whether an occupant can operate a button. When occupant operates a button, a synthetic voice will be announced on both sides.” Subsequently, further voice guidance is implemented to tell, “This is a request to occupant. If you can operate a button, please press the ◯◯ button on the steering handle. When the ◯◯ button is pressed within 10 seconds, audio guidance is implemented to tell, “◯◯ button is pressed” in the form of the voice prompt. Further audio guidance is implemented for confirmation to tell, “this is a request to occupant. If you can operate a button, please press the ▾▾ button on the steering handle” (▾▾ is optional). When the ▾▾ button is pressed within 10 seconds, audio guidance is implemented to tell, “▾▾ button is pressed. Communications may be made with a button. Operation is completed.” Subsequently, further audio guidance is implemented to the information center 31 in the form of the voice prompt to request a response by telling, “Please talk to the occupant from the center side and inquire whether the occupant requires rescue. The occupant may be able to operate buttons.” Thus, the operator of the information center 31 determines the occupant's condition and demands dispatch of rescue staff if necessary.

As described above, the operator implements the instructions to the occupant with a voice. It is noted that, even if malfunction of the speaker 4 is not notified, the speaker 4 may malfunction. In consideration of this, it is effective to transmit a message display command from the information center 31 to the vehicular device 10 to cause the vehicular device 10 to indicate a message. Specifically, in this case, when receiving the message display command, the vehicular device 10 causes the display device of the navigation device 1 to indicate letters representing the message of the message display command and/or to cause the speaker 4 to emit a sound (voice) representing the message. The message may represent, for example, the progress of the countermeasure or transmission for the emergency notification, the arrival time of an emergency vehicle such as an ambulance, and/or the like. In this way, the above-described occupant's condition is confirmed by the button operation to generate a message. Thereby, the condition of occupant's injury can be confirmed.

(When Speaker 4 Malfunctions)

When malfunction of the speaker 4 is notified, the operator of the information center 31 can hear occupant's voice, nevertheless, the operator cannot talk to the occupant. In this case, the vehicular device 10 transmits to the information center 31 in the form of the voice prompt to tell, “The speaker malfunctions and your voice may not be transferred.” In response to this, the operator of the information center 31 transmits a message display command to the vehicular device 10. The vehicular device 10 is configured to cause the display device of the navigation device 1 to indicate the message represented by the received message display command. Specifically, the vehicular device 10 is configured to cause the display device to indicate a template message such as “Notification is received.” and/or “An ambulance is dispatched there.”

Specifically, the vehicular device 10 calls the information center 31 and is connected with the information center 31. Further, the vehicular device 10 transmits the following contents to both the information center 31 and the occupant thereby to determine whether communications by the transmission of letters is possible. Specifically, the audio guidance is made in the form of the voice prompt to include the contents of, “This is a report of detection of collision inflating an airbag. The vehicle ID is Mikawa, ◯◯α, Δ-XX-YY. The registered owner is Mr. ΔΔ. The vehicle position is at the longitude xx east and at the latitude yy north. The number of occupants may be zz. Please talk from the center side to the occupant. The speaker of the vehicle may malfunction according to the self-diagnostic result. Therefore, the communication may be one-way.” Simultaneously, the display device of the navigation device 1 is caused to indicate, “Malfunction of speaker may be detected.” When, for example, 30 seconds elapse, a message is transmitted and indicated in the form of the voice prompt that, “This is a request to the center side. Guidance will follow to request operation for figuring out whether occupant can communicate with text information. Please operate a numerical button on the telephone in line with the guidance. When you operate a button, the text information will be indicated in the vehicle.” Further, a message is transmitted and indicated in the form of the voice prompt that, “This is a request to the center side. Please press the ◯◯ button of the telephone.” When the operator pushes the ◯◯ button on the telephone, the telephone transmits a dial tone multi frequency signal (DTMF signal) to the vehicular device 10. Specifically, when one button is pressed, the DTMF signal including two sound signals different in frequency is sent. Thus, the pressed button can be determined according to the sound signals.

The vehicular device 10 decodes the DTMF signal sent from the telephone, thereby to determine the pressed button based on the signal. The vehicular device 10 further indicates the predetermined template sentence being beforehand associated with the button. After about 10 seconds elapse, when the ◯◯ button is pressed, the vehicular device 10 transmits and indicates in the form of the voice prompt, for example, “indication is made that, please speak “text is readable” when you can read the text,” which is a template sentence on the side of the vehicle. Subsequently, the vehicular device 10 transmits and indicates in the form of the voice prompt, “Please request communications from the center side to the occupant with text, and please inquire whether the occupant requires rescue. Occupant's voice may be transmitted to the center,” thereby to request a response. Thus, the information center 31 determines the occupant's condition and demands dispatch of rescue staff if necessary.

Even with a talking from the operator to the occupant via such a one-way communication, the operator can estimate the present condition. Therefore, the operator can implement a countermeasure appropriately to the estimated condition.

(When Microphone 3 and the Speaker 4 Malfunction)

When malfunctions of both the microphone 3 and the speaker 25 are notified, the vehicular device 10 transmits to the information center 31 in the form of the voice prompt that “The microphone and the speaker malfunction, and therefore, your voice may not be transferred.” Thus, the operator of the information center 31 determines that there is no way to communicate with the occupant. Thus, the operator requests dispatch of a rescue staff, such as a police staff and/or a fire fighting staff.

With the present embodiment, the following effects can be produced.

In a state of emergency of the vehicle, when connection is made with the information center 31 other than the emergency information center, the vehicle information is transmitted to the information center 31 in the form of the voice prompt including analog data. With the present configuration, even when the communication environment of the information center 31 is a telephone (cellular phone) of a police headquarter, a fire fighting headquarter, and/or a person receivable only analog data, the operator of the information center 31 is enabled to confirm the condition on the side of a vehicle and is enabled to implement a suitable countermeasure to the state of emergency.

In addition, the vehicle information is generated to include the malfunction information representing malfunction of the microphone 3 and/or the speaker 4 and is transmitted. Therefore, the operator of the information center 31 can handle the accident appropriately according to the malfunctioning external device(s).

The content of the button pressed by the occupant is transmitted in the form of the voice prompt. Therefore, even when the microphone 3 malfunctions, response to the operator's instruction is enabled. Thus, suitable countermeasure can be implemented.

The DTMF signal is generated according to the button operation of the telephone of the information center 31 and transmitted as the message display command to the vehicular device 10. Therefore, the message display commands can be easily transmitted by the button operation on the telephone of the information center 31.

### Other Embodiments

The present invention is not limited to the above embodiment and can be transformed or extended as follows.

The subsequent connected destination when connection cannot be made with the emergency information center is not limited to one connected destination. For example, the subsequent connected destination may be selected from multiple connected destinations arbitrarily according to the priority.

The vehicle information in the form of the voice prompt received by the information center 31 may be recognized automatically, thereby to implement the following countermeasure automatically. Specifically, for example, when the vehicle information is received, the received vehicle information may be automatically transferred to a nearby entity such as a police headquarter and/or a fire fighting headquarter.

The vehicular device 10 may be equipped with a manual operation button and/or a display device.

Summarizing the above embodiments, the vehicular device is configured to transmit the vehicle information in the form of the voice prompt of analog data when being in connection with the information center. Therefore, the vehicle information can be received by the information center even in a case where the information center is a police headquarter, a fire fighting headquarter, and/or a telephone (cellular phone device) of a person capable of receiving only analog data. The vehicular device is configured to transmit the vehicle information in the form of the voice prompt to the information center when a state of emergency occurs. With the present configuration, the information center can suitably handle the state of emergency according to the vehicle information. When the speaker and/or the microphone being the external device malfunctions due to an impact in a state of emergency, the vehicular device may transmit the malfunction information on the external device in the form of the voice prompt. With the present configuration, the operator of the information center can suitably handle the state of emergency according to the malfunction external device.

When an occupant operates the operation unit according to an instruction of the operator, the vehicular device may be configured to respond to the instruction of the operator even in a case where the microphone malfunctions. With the present configuration, appropriate countermeasure can be implemented.

The vehicular device may be further configured to receive the message display command transmitted from the information center and to notify the occupant of the instruction of the operator, even in a case where the speaker malfunctions.

A configuration may be employed to cause the information center to transmit the message display command easily by the button operation on the telephone of the information center.

The above processings such as calculations and determinations are not limited being executed by the CPU 12. The control unit may have various structures including the CPU 12 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A vehicular device comprising:
a communication unit configured to connect with an information center, which is configured to receive analog data, through an external network; and
a transmission unit configured to transmit predetermined vehicle information in a form of a voice prompt of analog data when the communication unit is in connection with the information center.

2. The vehicular device according to claim 1, further comprising:
an emergency state detection unit configured to detect occurrence of an emergency state on a vehicle equipped with the vehicular device, wherein
the transmission unit is further configured to transmit the vehicle information to the information center in the form of the voice prompt when the emergency state detection unit detects the occurrence of the emergency state.

3. The vehicular device according to claim 2, further comprising:
a microphone equipped as an external device and configured to receive a voice uttered by an occupant;
a receiving unit configured to receive a voice from the information center;
a speaker equipped as an external device and configured to utter the voice received by the receiving unit; and
a malfunction detection unit configured to detect malfunction of at least one of the external devices, wherein
the transmission unit if further configured to transmit malfunction information on the at least one of the external devices detected by the malfunction detection unit, as the vehicle information.

4. The vehicular device according to claim 1, further comprising:
an operation unit operational by an occupant, wherein
the transmission unit is further configured to transmit a content of an operation of the operation unit in the form of the voice prompt.

5. The vehicular device according to claim 1, wherein
the receiving unit is further configured to receive a message display command from the information center,
the vehicular device further comprising:
an indication unit configured to indicate a message according to the message display command received by the receiving unit.

6. The vehicular device according to claim 5, further comprising:
a storage unit configured to store a template sentence corresponding to a dial tone multi frequency signal, wherein
the message display command includes the dial tone multi frequency signal representing an operation on a number button of a telephone of the information center, and
the indication unit is further configured to decode the dial tone multi frequency signal and to indicate the template sentence stored in the storage unit and corresponding to the dial tone multi frequency signal.

7. A vehicular device for a vehicle comprising:
a communication unit configured to connect with an information center, which is configured to receive analog data and incapable of receiving digital data, through an external network; and
a transmission unit configured to transmit predetermined vehicle information in a form of a voice prompt of analog data correspondingly to the information center, when the communication unit is in connection with the information center.

8. A vehicular device comprising:
a communication unit configured to connect with an information center through an external network;
a determination unit configured to determine whether the information center is configured to receive analog data and incapable of receiving digital data; and
a transmission unit configured to transmit predetermined vehicle information in a form of a voice prompt of analog data, on determination of the determination unit that the information center is configured to receive analog data and incapable of receiving digital data, when the communication unit is in connection with the information center.

9. A method for communicating a vehicular device with an information center, which is configured to receive analog data and incapable of receiving digital data, the method comprising:
causing a communication unit of the vehicular device with the information center through an external network; and
causing a transmission unit of the vehicular device to transmit predetermined vehicle information in a form of a voice prompt of analog data correspondingly to the information center, when the communication unit is in connection with the information center.

10. A non-transitory computer readable medium comprising instructions executed by a computer, the instructions including the method according to claim 9.

11. A method for communicating a vehicular device with an information center, the method comprising:
causing a communication unit of the vehicular device with the information center through an external network;
causing a determination unit of the vehicular device to determine whether the information center is configured to receive analog data and incapable of receiving digital data; and
causing a transmission unit of the vehicular device to transmit predetermined vehicle information in a form of a voice prompt of analog data correspondingly to the information center, on determination that the information center is configured to receive analog data and incapable of receiving digital data, when the communication unit is in connection with the information center.

12. A non-transitory computer readable medium comprising instructions executed by a computer, the instructions including the method according to claim 11.
